(19) United States
(12) Patent Application Publication
(10) Pub. No.: US 2026/0221479 A1
(43) Pub. Date: Jul. 30, 2026

(54) REINFORCED ION-CONDUCTING MEMBRANE

(71) Applicant: JOHNSON MATTHEY HYDROGEN TECHNOLOGIES LIMITED, LONDON (GB)

(72) Inventors: Josef BOBOLECKI, Swindon Wiltshire (GB); Emily NESLING, Swindon Wiltshire (GB); Wayne TURNER, Swindon Wiltshire (GB)

(21) Appl. No.: 19/143,740

(22) PCT Filed: Mar. 15, 2024
(86) PCT No.: PCT/GB2024/050692

§ 371 Date: Jun. 26, 2025

(30) Foreign Application Priority Data
Mar. 16, 2023 (GB) 2303838.3

(51) Int. Cl. H01M 8/1004; B01J 39/19; C25B 9/23; C25B 13/02; C25B 13/08; H01M 8/10; H01M 8/1039; H01M 8/1058; H01M 8/1067

(52) U.S. Cl. CPC H01M 8/1004; B01J 39/19; C25B 9/23; C25B 13/02; C25B 13/08; H01M 8/1039; H01M 8/1058; H01M 8/1067; H01M 2008/1095; H01M 2300/0082

(57) ABSTRACT

The present invention provides a reinforced ion-conducting membrane comprising: (a) a reinforcing layer comprising a porous polymer structure; and (b) a polymeric ion-conducting membrane material impregnated within the porous polymer structure; wherein the porous polymer structure comprises a polymer backbone based on nitrogen-containing heterocycles and the polymeric ion-conducting membrane material has a transition temperature Ta in the range of and including 60 to 80° C.

### FIELD OF THE INVENTION

This invention relates to reinforced ion-conducting membranes. In particular, this invention relates to reinforced proton exchange membranes, and methods of manufacturing the same. The reinforced ion-conducting membranes can be suitable for use in electrochemical devices such as fuel cells and/or electrolysers.

### BACKGROUND OF THE INVENTION

A fuel cell is an electrochemical cell comprising two electrodes separated by an electrolyte. A fuel, e.g. hydrogen, an alcohol such as methanol or ethanol, or formic acid, is supplied to the anode and an oxidant, e.g. oxygen or air, is supplied to the cathode. Electrochemical reactions occur at the electrodes, and the chemical energy of the fuel and the oxidant is converted to electrical energy and heat. Electrocatalysts are used to promote the electrochemical oxidation of the fuel at the anode and the electrochemical reduction of oxygen at the cathode.

Fuel cells are usually classified according to the nature of the electrolyte employed. Often the electrolyte is a solid polymeric membrane, in which the membrane is electronically insulating but ionically conducting. In the proton exchange membrane fuel cell (PEMFC) the membrane is proton conducting, and protons, produced at the anode, are transported across the membrane to the cathode, where they combine with oxygen to form water.

An electrolyser is an electrochemical device for electrolysing water to produce high purity hydrogen and oxygen. Electrolysers can operate in both alkaline and acidic systems. Those electrolysers that employ a solid proton-conducting polymer electrolyte membrane, or proton exchange membrane (PEM), are known as proton exchange membrane water electrolysers (PEMWEs). Those electrolysers that utilise a solid anion-conducting polymer electrolyte membrane, or anion exchange membrane (AEM), are known as anion exchange membrane water electrolysers (AEMWEs).

Conventional ion-conducting membranes used in PEMFCs or PEMWEs are generally formed from sulfonated fully-fluorinated polymeric materials (often generically referred to as perfluorinated sulphonic acid (PFSA) ionomers). As an alternative to PFSA type ionomers, it is possible to use ion-conducting membranes based on partially-fluorinated or non-fluorinated hydrocarbon sulfonated or phosphonated polymers.

Recent developments in fuel cells and electrolysers require membranes to be thinner due to the advantages obtained (improved ionic conductivity, improved water transport etc.). However, it is also imperative that membranes have high durability under the often-harsh fuel cell or electrolyser operating conditions, so that such components do not lead to premature system failure.

In order to provide the mechanical properties required to increase resistance to premature failure, a reinforcement, typically expanded polytetrafluoroethylene (ePTFE), is embedded within the membrane. Other types of reinforcement have also been proposed. For example it is disclosed in WO2016020668A1 that heterocyclic-based polymers may be used as reinforcement components.

There remains a need to develop improved ion-conducting membranes with enhanced durability under for fuel cell and electrolyser operating conditions.

### SUMMARY OF THE INVENTION

It is an object of the present invention to provide an improved reinforced ion-conducting membrane, suitably for use in electrochemical devices, such as fuel cells and electrolysers, and in particular having improved durability.

Accordingly, in a first aspect of the invention there is provided a reinforced ion-conducting membrane comprising:
(a) a reinforcing layer comprising a porous polymer structure; and
(b) a polymeric ion-conducting membrane material impregnated within the porous polymer structure;
wherein the porous polymer structure comprises a polymer backbone based on a nitrogen-containing heterocycle and the polymeric ion-conducting membrane material has a transition temperature Ta in the range of and including 60 to 80° C.

It has been surprisingly found that the combination of the use of reinforcement layer(s) comprising a nitrogen-containing heterocycle-based polymer and an ion-conducting membrane material with a selected transition temperature Ta yields membrane components for electrochemical devices with exceptional durability as shown in the Examples.

Reinforced ion-conducting membranes of the first aspect are particularly suitable for use as electrolyte membranes in fuel cells and electrolysers.

Reinforced ion-conducting membranes of the first aspect may advantageously be used to produce catalyst-coated membranes with high durability. Therefore, in a second aspect of the invention, there is provided a catalyst-coated membrane for a fuel cell or a water electrolyser comprising a reinforced ion-conducting membrane according to the first aspect, with a cathode catalyst layer applied to a first face of the membrane and/or an anode catalyst layer applied to a second face of the membrane.

### BRIEF DESCRIPTION OF THE DRAWINGS

FIG. 1 shows the results of cyclic open circuit voltage-relative humidity (COCV-RH) accelerated stress testing of Example 1 and Comparative Examples 1 and 2.

FIG. 2 shows the results of cyclic open circuit voltage-relative humidity (COCV-RH) accelerated stress testing of Example 2 and Comparative Example 3.

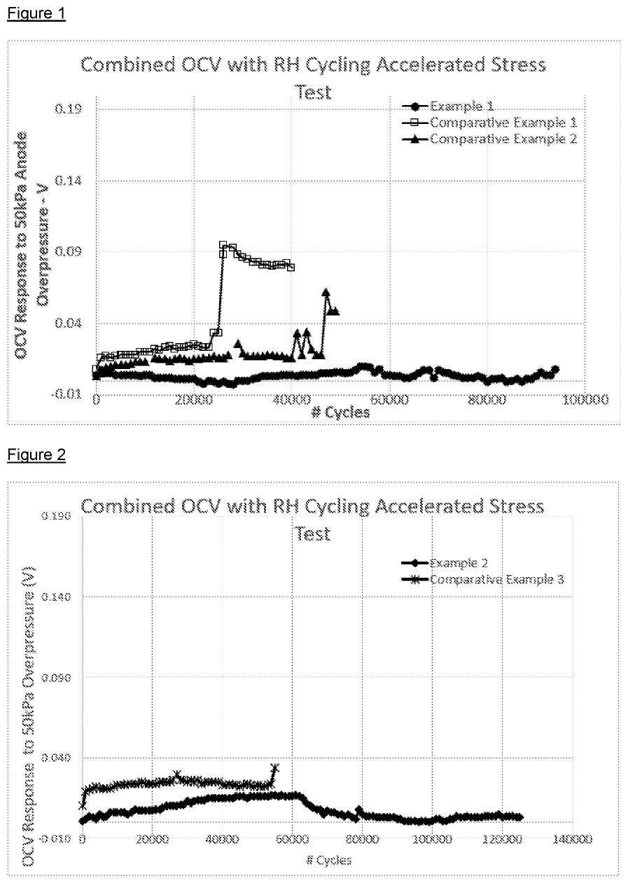

### DETAILED DESCRIPTION OF THE INVENTION

Preferred and/or optional features of the invention will now be set out. Any aspect of the invention may be combined with any other aspect of the invention, unless the context demands otherwise. Any of the preferred or optional features of any aspect may be combined, singly or in combination, with any aspect of the invention, unless the context demands otherwise.

The present invention provides reinforced ion-conducting membranes, such as a polymer electrolyte membrane, comprising a reinforcing layer and a polymeric membrane ion-conducting polymer. The present inventors have identified that the use of a polymeric membrane ion-conducting polymer with a transition temperature Ta in the range of and including 60 to 80° C. is particularly advantageous when combined with reinforcing porous polymer structures comprising a backbone comprising a nitrogen-containing heterocycle, such as a polybenzimidazole.

Typically, porous nitrogen-containing heterocyclic polymer structures have an increased rigidity in comparison with other reinforcement materials, such as those based on aliphatic backbones. In order to maintain high membrane conductivity, it is required that the polymeric ion-conducting membrane material is impregnated within the porous polymer structure. Without being bound by theory, it is considered that the use of a polymeric ion-conducting membrane material with a transition temperature Ta in the range of and including 60 to 80° C. is advantageous in combination with such reinforcement materials as the impregnated membrane material has a greater ability to absorb and diffuse stresses resulting from strains that occur during operation under fluctuating relative humidity in comparison to ion-conducting membrane materials with a higher Ta transition temperature. This leads to a reduction in the formation of defects and cracks in the membrane material which can lead to membrane rupture during use (which typically involves variation in membrane water content causing the impregnated ion-conducting membrane material to swell or contract). Furthermore, it has been found that nitrogen-containing heterocyclic polymer structures can provide additional durability benefits associated with scavenging radical species formed during membrane operation.

The reinforced ion-conducting membrane comprises a reinforcing layer comprising a porous polymer structure which provides mechanical reinforcement to the ion-conducting membrane and comprises a polymer backbone based on a nitrogen-containing heterocycle. The nitrogen-containing heterocycle may comprise basic functional groups. The nitrogen-containing basic functional groups can be nitrogen with a lone pair. The polymer backbone can be suitably derived from polybenzimidazoles, poly(pyridine)s, poly(pyrimidine)s, polybenzthiazoles, polyoxadiazoles, polyquinolines, polyquinoxalines, polythiadiazoles, polytriazoles, polyoxazoles, polybenzoxazoles, polythiazoles, polypyrazoles, and derivatives thereof. Suitably, the polymer backbone is derived from a functionalised polyazole or a zwitterionic polyazole, such as a polybenzimidazole, polytriazole, polythiazole and polydithiazole and their derivatives; most suitably a polybenzimidazole. It will be understood by the skilled person that the polymer backbone may comprises more than one type of nitrogen-containing heterocycle, or a mixture of a nitrogen-containing heterocycles and other aliphatic or aromatic groups.

Suitably, the porous polymer structure comprises a porous mat of nanofibers. The porous mat is suitably formed from entangled nanofibres. Typically, the nanofibres are ionically non-conductive. For example, the nanofibres are suitably devoid of sulphonic acid groups and/or phosphoric acid groups. The nanofibres may comprise discrete nanofibres that are entwined. For example, the nanofibres can cross each other or be twisted with other nanofibres or itself. The porous mat of nanofibres can be in the form of a non-woven fabric material. Suitably, the nanofibres have a substantially random orientation in the plane of the reinforced ion-conducting membrane (i.e. the xy plane). The nanofibres suitably have a diameter of 50-700 nm, suitably 200-600 nm and preferably 250-550 nm. The length of the nanofibres is not material to the invention, but each nanofibre should be sufficiently long (for example several millimetres or centimetres) to be entangled, either with one or more other nanofibres or with itself. The nanofibres are suitably spun nanofibres, i.e. the nanofibres are formed using a spinning technique. Examples of suitable spinning techniques include, but are not limited to, electrospinning and force spinning.

The porous polymer structure may comprise a second polymer which is typically ionically non-conductive. The second polymer is different (i.e. in the sense that it has a different chemical composition) to the heterocyclic-based polymer from which the heterocyclic-based polymer backbones are derived. The second polymer can be a partially- or fully-fluorinated polymer or a hydrocarbon polymer. Preferably, the second polymer is a partially- or fully-fluorinated polymer. For example, the second polymer can be selected from the group consisting of: poly(vinylidene difluoride) (PVDF), polytetrafluoroethylene (PTFE), polyethersulfone (PES), poly(vinylidene fluoride-co-hexafluoropropylene) (PVDF-HFP), polyimides (PI), polyetherimide (PEI), poly(aryl ether ketone) (PAEK), poly(aryl ether sulfone), poly(phenylene sulfide) (PPS), polyvinylpyrrolidone (PVP). Preferably, the second polymer is PVDF. Providing a porous polymer structure, such as a porous mat of nanofibers, which includes a polymer comprising a polymer backbone based on nitrogen-containing heterocycles and the second polymer, can further improve the mechanical and tensile properties of the porous polymer structure, and hence the reinforced ion-conducting membrane.

It may be preferred that the porous polymer structure does not comprise a second polymer. It may be preferred that the porous polymer structure does not comprise PTFE. It may be preferred that the porous polymer structure consists essentially of a polymer with a backbone based on a nitrogen-containing heterocycle. It may be preferred that the porous polymer structure is formed of at least 95 wt % of a polymer with a backbone based on a nitrogen-containing heterocycle based on a total weight of the porous polymer structure, such as at least 98 wt %.

The porous polymer structure suitably has an average basis weight in the range 1 g/m² to 7 g/m², suitably in the range 1.5 g/m² to 4 g/m², or preferably 1.5 g/m² to 3 g/m², or 1.5 g/m² to 3 g/m². The average base weight is determined from the porous polymer structure in the absence of reinforced ion-conducting membrane, i.e. before incorporation into the membrane. It will be understood that, in the case that the porous polymer structure has more than one reinforcing layer the average basis weight refers to the average base weight of each individual porous polymer structure incorporated into the reinforced ion-conducting membrane.

Suitably, the porous polymer structure in the reinforced ion-conducting membrane has a maximum thickness of 100% of the thickness of the reinforced ion-conducting membrane such as a maximum thickness of 90%, 80%, 70%, 60%, or 50% of the thickness of the reinforced ion-conducting membrane. The porous polymer structure in the reinforced ion-conducting membrane suitably has a minimum thickness of 5% of the thickness of the reinforced ion-conducting membrane, such as a minimum thickness of 10%, 15%, 20%, 25% or 30% of the thickness of the reinforced ion-conducting membrane. It may be preferred that the porous polymer structure in the reinforced ion-conducting membrane may have a thickness in the range of and including 5 to 95% of the thickness of the reinforced ion-conducting membrane, such as a thickness in the range of and including 10 to 90% or 20 to 80% of the thickness of the reinforced ion-conducting membrane. It will be understood that, in the case that the reinforced ion-conducting membrane has more than one reinforcing layer the maximum and/or minimum thickness is the sum of the thickness of each porous polymer structure. The thickness of the or each porous polymer structure, as a proportion of the reinforced ion-conducting membrane may be determined, for example, from a scanning electron microscope (SEM) image of a cross section of the reinforced ion-conducting membrane.

The polymeric ion-conducting membrane material has a transition temperature Ta in the range of and including 60 to 80° C. The ion-conducting membrane materials exhibit a thermal transition between a state in which clusters of ionic groups are closely associated and a state in which the interactions between those clusters have been weakened therefore allowing for long range molecular motion. This transition is described as an alpha transition, and the transition temperature is Tα or T alpha. The transition temperature Tα of the ion-conducting membrane material is measured by subjecting a sample of the membrane to dynamic mechanical analysis at a relative humidity of 0%, an oscillation frequency of 1 Hz, and a temperature sweep rate of 1° C./min. The transition temperature Tα is suitably derived from a plot of Tan delta vs temperature and is the temperature at which the Tan delta value is at its maximum.

It may be preferred that the polymeric ion-conducting membrane material has a transition temperature Tα in the range of and including 62 to 78° C., such as 63 to 77° C., 64 to 76° C., or 65 to 75° C.

The polymeric ion-conducting membrane material is impregnated within the porous polymer structure. Preferably, the porous polymer structure is essentially fully impregnated with the polymeric ion-conducting membrane material.

The porous polymer structure is essentially fully impregnated with ion-conducting membrane material to form the ion-conducting (electrolyte) membrane. By “essentially fully impregnated” is meant that at least 80%, suitably at least 90%, suitably at least 95% and ideally 100% of the pores of the porous polymer structure are filled with ion-conducting polymer.

Suitably, excess membrane material is present on both surfaces of the ion-conducting (electrolyte) membrane to aid adhesion to a catalyst layer.

Suitably, the ion-conducting membrane material is formed from a proton-conducting polymer. Preferably, the ion-conducting membrane material comprises sulfonic acid groups. The ion-conducting membrane material preferably comprises a perfluorinated sulfonic acid (PFSA) ionomer, a partially-fluorinated sulfonic acid ionomer, a non-fluorinated hydrocarbon sulfonic acid ionomer, or mixtures thereof. It may be further preferred that the ion-conducting membrane material comprises a perfluorinated sulfonic acid ionomer or a partially-fluorinated sulfonic acid ionomer. It may be particularly preferred that the ion-conducting membrane material comprises a perfluorinated sulfonic acid ionomer. The ion-conducting membrane material may comprise a blend of proton-conducting polymers, such as a blend of perfluorinated sulfonic acid ionomers. The Tα of proton-conducting polymers may be varied, for example, by incorporation of modifying monomers. For example, it is disclosed in U.S. Pat. No. 11,492,431 B2, which is incorporated herein by reference, that the incorporation of perfluoroalkyl vinyl ethers and/or perfluoroalkoxyalkyl allyl ether monomers can be used to vary Tα. It may be preferred that the ion-conducting membrane material comprises a perfluorinated sulfonic acid ionomer which incorporates perfluoroalkyl vinyl ether and/or perfluoroalkoxyalkyl allyl ether monomers. The Tα of membrane materials can be readily determined by the skilled person as set out herein. Suitable ion-conducting polymers of utility in forming an ion-conducting membrane material with a Tα in the desired range are known to the skilled person, and include PFSA ionomer IQ171 (AGC Inc).

Suitably, the reinforced ion-conducting membrane has a thickness at 0% relative humidity of at least about 5 μm. It may be preferred that the reinforced ion-conducting membrane has a thickness of at least about 6 μm, 7 μm, 8 μm, 9 μm or at least about 10 μm. Typically, the thickness of the reinforced ion-conducting membrane at 0% relative humidity is less than or equal to about 200 μm, such as less than or equal to 150 μm, less than or equal to 100 μm, less than or equal to 50 μm, less than or equal to 30 μm, less than or equal to 25 μm, or less than or equal to 20 μm. The thickness of the membrane may be determined by analysis of a scanning electron microscope (SEM) image of a cross section of the membrane. It may be preferred that the membrane has a thickness at 0% relative humidity in the range of and including 5 μm to 200 μm, 6 to 100 μm, 6 to 50 μm, 7 to 30 μm, or 8 to 20 μm.

The reinforced ion-conducting membrane may suitably contain one reinforcing layer. Suitably, the reinforced ion-conducting membrane has one reinforcing layer and has a thickness at 0% relative humidity in the range of and including 8 μm to 30 μm. Such membrane materials have an excellent combination of durability and conductivity. For some applications a thicker membrane is preferred, for example to reduce hydrogen crossover in electrolyser applications. It may be preferred that the reinforced ion-conducting membrane has one reinforcing layer and has a thickness at 0% relative humidity in the range of and including 30 μm to 70 μm.

The reinforced ion-conducting membrane may suitably contain two or more reinforcing layers. Suitably, the reinforced ion-conducting membrane has two reinforcing layers and has a thickness at 0% relative humidity in the range of and including 60 μm to 90 μm. Such membranes offer an excellent combination of durability and strength whilst maintaining high ion conductivity. Such membranes may be of particular utility when during operation there is a large difference in the gas pressure on opposite sides of the membrane.

It is considered that the benefits of using a polymeric ion-conducting membrane material with a transition temperature Tα in the range of and including 60 to 80° C. may be particularly observed when the relative proportion of reinforcement material is relatively high which provides additional constraints on the expansion of the ion-conducting material. Suitably, the porous polymer structure is present in a total content of at least about 10 vol % based on the total volume of the reinforced ion-conducting membrane. The vol % of the porous polymer structure refers to the space occupied by the porous polymer structure which is free of ion-conducting membrane material (i.e. before incorporation into the membrane) and is calculated as a proportion of the volume of the total volume of the reinforced ion-conducting membrane (with the volume of porous polymer structure and membrane measured at 0% relative humidity). The porous polymer structure may be present in a total content of at least about 12 vol %, at least 15 vol %, or at least 18 vol %. The porous polymer structure may be present in a total content in the range of and including 10 to 30 vol %. It will be understood by the skilled person that in the case of reinforced ion-conducting membrane having two or more reinforcing layers then the total content of the porous polymer structure is calculated as the sum of the volume of each porous polymer structure incorporated into the membrane.

The use polymeric ion-conducting membrane material with a transition temperature Tα in the range of and including 60 to 80° C. is also considered to be of particular utility when the reinforced ion-conducting membrane has a high resistance to extension under tension at elevated temperature and humidity. Such resistance to extension at elevated temperature and humidity is beneficial to avoid durability issues which can arise, for example, from cracking of applied catalyst layers, or varying rates of expansion of MEA components.

Therefore, suitably the reinforced ion-conducting membrane has a machine direction (MD) stress at 8% strain at 80° C. and 90% relative humidity of at least 3.0 MPa. It may be preferred that the reinforced ion-conducting membrane has a machine direction (MD) stress at 8% strain at 80° C. and 90% relative humidity of at least 3.5, at least 4.0, at least 4.5, at least 5.0, at least 5.5, at least 6.0, at least 6.5, or at least 7.0 MPa. The maximum machine direction (MD) stress is not particularly limited in the current invention but typically is less than 10 MPa, for example in the range of and including 3.0 to 10 MPa.

Suitably the reinforced ion-conducting membrane has a transverse direction (TD) stress at 8% strain at 80° C. and 90% relative humidity of at least 2.5 MPa. It may be preferred that the reinforced ion-conducting membrane has a transverse direction (MD) stress at 8% strain at 80° C. and 90% relative humidity of at least 3.0, at least 3.5, at least 4.0, at least 4.5, at least 5.0, at least 5.5, or at least 6.0. The maximum machine direction (MD) stress is not particularly limited in the current invention but typically is less than 8 MPa, for example in the range of and including 2.5 to 8 MPa.

The stress at 8% strain at 80° C. and 90% relative humidity (in the transverse and machine directions) may be measured by subjecting a sample of the membrane to dynamic mechanical analysis at a relative humidity of at 80° C. and 90% relative humidity with a stress ramp rate of 0.2 MPa/min.

The polymeric ion-conducting membrane material typically has an equivalent weight (EW) in the range of and including 450 to 1000, for example 450 to 900, 450 to 850, or 450 to 800. The equivalent weight of the copolymer is the weight of copolymer required to provide 1 mole of exchangeable protons. The equivalent weight of the copolymer may be readily measured using an acid titration following a hydroxide exchange. For example, a membrane sample may be vacuum dried at 110° C. for 16 hours to obtain about 2 g of the dried film. The film may then be immersed in about 30 mL of a 0.1N NaOH solution to substitute sodium ions for protons in the membrane. Then titration by neutralisation is carried out, for example using 0.1N hydrochloric acid, to determine the number of exchangeable protons, and therefore the EW may be calculated.

The reinforced ion-conducting membrane may further comprise additives, such as supported or unsupported recombination catalyst particles, for example platinum catalyst particles (optionally on a carbon or metal oxide support). and radical scavengers (such as a cerium- or manganese-containing compound, for example a cerium oxide, cerium metal oxide, manganese oxide, or a cerium salt or a manganese salt). It may be preferred that the reinforced ion-conducting membrane comprises cerium oxide, for example nanoparticulate cerium oxide. It has been found by the inventors that porous polymer structures which include a polymer backbone based on nitrogen-containing heterocycles, such as polybenzimidazole, have the ability to remove radical species. Therefore, it may be preferred that the reinforced ion-conducting membrane does not comprise a cerium-containing compound or a manganese-containing compound (such as a cerium- or manganese-containing compound, for example a cerium oxide, cerium metal oxide, manganese oxide, or a cerium salt or a manganese salt). By does not comprise a cerium-containing compound or a manganese-containing compound, it is meant herein that the reinforced ion-conducting membrane does not have any intentionally added cerium-containing or manganese-containing compounds, but this does not preclude the presence of impurity levels of cerium-containing or manganese-containing compounds.

The reinforced ion-conducting membranes may be manufactured using methods known to those skilled in the art. The porous polymer structure may be suitably formed by a spinning technique, onto a suitable substrate or surface, for example, the porous polymer structure may be formed using electrospinning.

In an example of a suitable process, an electrospinning formulation is provided comprising at least one nitrogen-containing heterocyclic based polymer, and optionally a second polymer, in a suitable solvent, such as an organic solvent, or suitable solvent mix. The solvent may suitably comprise (or consist of) at least one of N-methylpyrrolidone (NMP), dimethylformamide (DMF), dimethylacetamide (DMAc) and/or dimethylsulphoxide (DMSO), suitably DMAc and/or DMSO. The electrospinning formulation can be a solution or a dispersion. The electrospinning formulation is pushed through a needle using a syringe pump, wherein the needle is maintained at a potential difference with respect to the substrate/surface. Electrospun nanofibres are collected on a substrate (e.g. rotating drum collector) moving translationally and rotationally which is set at some distance from the needle, such as around 10-15 cm from the needle. The fibre morphology is obtained through control of the formulation parameters, such as concentration, whereas mat thickness and uniformity is controlled through deposition time and collector rotation/translation speed.

The porous polymer structure is impregnated with an ion-conducting polymer to form a reinforced ion-conducting membrane. The porous polymer structure can be impregnated with the ion-conducting polymer as part of a roll-to-roll process.

The porous polymer structure may be impregnated with the ion-conducting polymer by the following process. A layer of ion-conducting polymer (in solution/dispersion) is cast onto a carrier material. While the layer of ion-conducting polymer is still wet, the porous polymer structure is laid into the wet layer and the ion-conducting polymer impregnates into one face of the porous polymer structure. A further layer of ion-conducting polymer is applied to a second face of the porous polymer structure and impregnates into the porous polymer structure from the second face. The impregnated porous polymer structure is dried and suitably annealed to form an ion-conducting (electrolyte) membrane.

The invention also provides a catalysed-coated membrane comprising a reinforced ion-conducting membrane as set out hereinbefore, with a cathode catalyst layer applied to a first face of the membrane and/or an anode catalyst layer applied to a second face of the membrane.

The catalyst layer comprises one of more electrocatalysts. The one or more electrocatalysts are independently a finely divided unsupported metal powder, or a supported catalyst wherein small nanoparticles are dispersed on electrically conducting particulate carbon supports. The electrocatalyst metal is suitably selected from
(i) the platinum group metals (platinum, palladium, rhodium, ruthenium, iridium and osmium),
(ii) gold or silver,
(iii) a base metal,
or an alloy or mixture comprising one or more of these metals or their oxides. The preferred electrocatalyst metal is platinum, which may be alloyed with other precious metals or base metals. A base metal is tin or a transition metal which is not a noble metal. A noble metal is a platinum group metal (platinum, palladium, rhodium, ruthenium, iridium or osmium), gold or silver. Suitable base metals include copper, cobalt, nickel, zinc, iron, titanium, molybdenum, vanadium, manganese, niobium, tantalum, chromium and tin. Preferred base metals are nickel, copper, cobalt, and chromium. More preferred base metals are nickel, cobalt and copper. If the electrocatalyst is a supported catalyst, the loading of metal particles on the carbon support material is suitably in the range 10-90 wt %, preferably 15-75 wt % of the weight of resulting electrocatalyst.

The exact electrocatalyst used will depend on the reaction it is intended to catalyse and its selection is within the capability of the skilled person.

The catalyst layer is suitably applied to a first and/or second face of the electrolyte membrane as an ink, either organic or aqueous. The ink may suitably comprise other components, which are included to improve the ionic conductivity within the layer. Alternatively, the catalyst layer can be applied by the decal transfer of a previously prepared catalyst layer.

The catalyst layer may further comprise additional components. Such additional components include, but are not limited to, a catalyst which facilitates oxygen evolution and therefore will be of benefit in cell reversal situations and high potential excursions, or a hydrogen peroxide decomposition catalyst. Examples of such catalysts and any other additives suitable for inclusion in the catalyst layer will be known to those skilled in the art.

The invention further provides a membrane electrode assembly comprising a reinforced ion-conducting membrane of the invention and a gas diffusion electrode and/or a porous transport layer on a first and/or second face of the ion-conducting membrane.

The invention further provides a membrane electrode assembly comprising a catalyst-coated ion-conducting membrane and a gas diffusion layer or porous transport layer present on the at least one catalyst layers.

The membrane electrode assembly may be made up in a number of ways including, but not limited to:
(i) an ion-conducting (electrolyte) membrane of the invention may be sandwiched between a first gas diffusion electrode or porous transport layer and a second gas diffusion electrode or porous transport layer (one anode and one cathode);
(ii) a catalysed ion-conducting (electrolyte) membrane of the invention having a catalyst layer on one side may be sandwiched between a gas diffusion layer or porous transport layer and a gas diffusion electrode or catalyst-coated porous transport layer, the gas diffusion layer or porous transport layer contacting the side of the catalysed ion-conducting (electrolyte) membrane having the catalyst component or;
(iii) a catalysed ion-conducting (electrolyte) membrane of the invention having a catalyst component on both sides may be sandwiched between a first gas diffusion layer or porous transport layer and a second gas diffusion layer or porous transport layer, e.g. one gas diffusion layer and one porous transport layer.

The anode and cathode gas diffusion layers are suitably based on conventional gas diffusion substrates. Typical substrates include non-woven papers or webs comprising a network of carbon fibres and a thermoset resin binder (e.g. the TGP-H series of carbon fibre paper available from Toray Industries Inc., Japan or the H2315 series available from Freudenberg FCCT KG, Germany, or the Sigracet® series available from SGL Technologies GmbH, Germany or AvCarb® series from Ballard Power Systems Inc., or woven carbon cloths. The carbon paper, web or cloth may be provided with a further treatment prior to being incorporated into a MEA either to make it more wettable (hydrophilic) or more wet-proofed (hydrophobic). The nature of any treatments will depend on the type of fuel cell and the operating conditions that will be used. The substrate can be made more wettable by incorporation of materials such as amorphous carbon blacks via impregnation from liquid suspensions, or can be made more hydrophobic by impregnating the pore structure of the substrate with a colloidal suspension of a polymer such PTFE or polyfluoroethylenepropylene (FEP), followed by drying and heating above the melting point of the polymer. For applications such as the PEMFC, a microporous layer may also be applied to the gas diffusion substrate on the face that will contact the electrocatalyst layer. The microporous layer typically comprises a mixture of a carbon black and a polymer such as polytetrafluoroethylene (PTFE).

The porous transport layer is suitably based on conventional porous transport substrates, such as a titanium mesh.

The invention further provides an electrochemical device comprising a reinforced ion-conducting membrane (e.g. electrolyte membrane), a catalysed reinforced ion-conducting membrane, or a membrane electrode assembly as hereinbefore described. The electrochemical device can be a fuel cell, such as a proton exchange membrane fuel cell. The electrochemical device can be an electrolyser, such as a water electrolyser.

The invention will be further described with reference to the following examples which are illustrative and not limiting of the invention.

### EXAMPLES

### Measurement of Tα

A TA instruments Q800 DMA equipped with film tension clamps was used to measure the Tα. Relative humidity was set to 0% by using dry gasses and an in-line moisture trap. A sample of membrane 6 mm wide was installed vertically between two clamps c.a. 16 mm apart. The instrument was set to the following settings:
Oscillation frequency: 1 Hz
Mode: ‘Multi-Frequency—Strain’
Amplitude: 10 μm
Static F: 0.001N
Force Track: 125%
Minimum Osc F: 0.0001N
Stabilisation cycles: 4
Average cycles: 3

The sample was equilibrated at 30° C. for an hour. The temperature was then ramped to at least 120° C. at a rate of 1.00° C./min.

Using either TA instruments ‘Universal Analysis’ or ‘Trios’ software the data was analysed by plotting Tan (δ) vs T. The plot was then smoothed using a ‘region width’ of 0.5° C. and the Tα was taken to be the temperature at which the smoothed Tan (δ) is at its maximum.

### Tensile Strength Measurements

Rectangular membrane samples 6 mm wide are cut and then their thickness is measured using a VL-50 micrometer from Mitutoyo, which uses a force of 0.01N. The samples are then installed into a Q800 Dynamic Mechanical Analyser from TA instruments (torque setting available on request), the clamps of which are set approximately 16 mm apart. The sample length is measured accurately by the Q800 instrument using a force of 0.001N. Keeping the initial force of 0.001N and a logging of a point every 2 seconds, the temperature is increased to 80° C. and the humidity to 90% RH. The stress is then ramped at a rate of 0.2 MPa/min until the movable clamp reaches the end of its movement range. The stress (MPa) at 8% strain may be identified from a plot of stress against strain.

### Formation of a Polybenzimidazole Reinforcement

A porous mat of polybenzimidazole nanofibers was produced using poly [2,2′-(m-phenylene)-5,5′-bibenzimidazole] by electrospinning using a method analogous to that described in WO2016/020668.

### General Method—Formation of an Ion-Conducting Membranes

Ion-conducting membranes with a target thickness of 10 to 15 μm and comprising a polymer reinforcement were manufactured using a roll-to-roll process comprising three coating passes which were carried out using a dispersion of an ion-conducing polymer in propanol-water including a cerium radical scavenging additive. The first pass deposited an ion-conducting polymer layer onto a PET backing sheet. This layer was then dried before the deposition of a second layer into which the polymer reinforcement was impregnated. The second layer was then dried before the deposition (and subsequent drying) of a third layer comprising ion-conducting polymer. The formed membrane was annealed at a temperature above the glass transition temperature of the ion-conducting polymer. After annealing, the membranes were tested to determine the Talpha of the ion-conducting membrane material. Membranes were produced with the following combinations:

| | | Ion-conducting | |
|---|---|---|---|
| Example | Reinforcement | polymer | Membrane Tα |
| Comparative | PBI (1.9 gsm) | PFSA Ionomer A | 85° C. |
| Example 1 | | Dyneon 800EW (3M | |
| | | Corporation) | |
| Comparative | ePTFE (4.7 | PFSA Ionomer B | Not determined |
| Example 2 | gsm) | IQ171/IQ191 (Asahi | |
| | | Glass Corporation) | |
| Example 1 | PBI (1.9 gsm) | PFSA Ionomer B | 67° C. |
| | | IQ171/IQ191 (Asahi | |
| | | Glass Corporation) | |

### COCV-RH Cycling Accelerated Stress Tests

Membrane electrode assemblies (MEA) were formed from the membranes produced using a hot-pressing method to apply a platinum-on-carbon catalyst layer on each side of the membrane to form a CCM, hot-pressing seals around the edge of the CCM to leave a defined active area, and then the addition of a gas diffusion layer on each side to form an MEA. Each MEA was subjected to a cyclic open circuit voltage-relative humidity (COCV-RH) cycling test at 90° C. with the differential pressure across the membrane detected at every 1000 cycles. Membrane failure is detected as a sharp increase in pressure differential from its nominal baseline. The results are shown in FIG. 4. As can be seen from this figure, the MEA formed from the membrane produced in Example 1 produced a huge improvement in MEA durability in comparison with either (i) the combination of a high Talpha ionomer and PBI reinforcement; or (ii) the combination of an ePTFE reinforcement with a low Talpha ionomer.

### ADDITIONAL EXAMPLES

Further membranes were produced using an alternative PFSA ionomer:

| | | Ion- | Membrane | |
|---|---|---|---|---|
| | | conducting | thickness | Membrane |
| Example | Reinforcement | polymer | (μm) | Tα |
| Example 2 | PBI (2.4 g/m²) | PFSA | 10 | 74° C. |
| | | Ionomer C | | |
| Comparative | ePTFE (4.7 g/m²) | PFSA | 15 | 85° C. |
| Example 3 | | Ionomer C | | |

The results of Combined OSV with RH cycling accelerated stress testing of MEAs incorporating the membranes formed in Example 2 and Comparative Example 3 are shown in FIG. 5. The results indicate that the combination of a PBI reinforcement and a membrane material with a Tα around 75° C. provides extremely high durability which is greater than that achieved with a membrane formed from the same PFSA ionomer but with an ePTFE reinforcement.

1. A reinforced ion-conducting membrane comprising:
(a) a reinforcing layer comprising a porous polymer structure; and
(b) a polymeric ion-conducting membrane material impregnated within the porous polymer structure;
wherein the porous polymer structure comprises a polymer backbone based on nitrogen-containing heterocycles and the polymeric ion-conducting membrane material has a transition temperature Tα in the range of and including 60 to 80° C.

2. A reinforced ion-conducting membrane according to claim 1, wherein the polymeric ion-conducting membrane material has a transition temperature Tα in the range of and including 65 to 75° C.

3. A reinforced ion-conducting membrane according to claim 1, wherein the membrane has a thickness at 0% relative humidity of at least about 8 μm, such as in the range of and including 10 to 100 μm.

4. A reinforced ion-conducting membrane according to claim 1, wherein the porous polymer structure comprises a porous mat of nanofibers.

5. A reinforced ion-conducting membrane according to claim 4, wherein the nanofibres are spun nanofibres.

6. A reinforced ion-conducting membrane according to claim 1, wherein the porous polymer structure is present in a total content of at least about 10 vol % based on a total volume of the reinforced ion-conducting membrane.

7. A reinforced ion-conducting membrane according to claim 1, wherein the membrane has a machine direction (MD) stress at 8% strain at 80° C. and 90% relative humidity of at least 3.0 MPa.

8. A reinforced ion-conducting membrane according to claim 1, wherein the membrane has a transverse direction (TD) stress at 8% strain at 80° C. and 90% relative humidity of at least 2.5 MPa.

9. A reinforced ion-conducting membrane according to claim 1, wherein the polymeric ion-conducting membrane material is a proton conducting polymer.

10. A reinforced ion-conducting membrane according to claim 1, wherein the ion-conducting membrane material comprises sulfonic acid groups.

11. A reinforced ion-conducting membrane according to claim 1, wherein the ion-conducting membrane material is a perfluorinated sulfonic acid ionomer, or a partially-fluorinated or non-fluorinated hydrocarbon sulfonic acid ionomer.

12-13. (canceled)

14. A reinforced ion-conducting membrane according to a claim 1, wherein the polymer backbone based on nitrogen-containing heterocycles is selected from the group consisting of: polybenzimidazoles, poly(pyridine)s, poly(pyrimidine)s, polybenzthiazoles, polyoxadiazoles, polyquinolines, polyquinoxalines, polythiadiazoles, polytriazoles, polyoxazoles, polybenzoxazoles, polythiazoles, polypyrazoles and derivatives thereof.

15. A reinforced ion-conducting membrane according to claim 1, wherein the polymer backbone based on nitrogen-containing heterocycles is a polybenzimidazole or a derivative thereof.

16. A reinforced ion-conducting membrane according to claim 1 comprising two or more reinforcing layers.

17. (canceled)

18. A reinforced ion-conducting membrane according to claim 1 comprising a recombination catalyst.

19. A reinforced ion-conducting membrane according to claim 1 which does not comprise a cerium-containing compound or a manganese-containing compound.

20. A reinforced ion-conducting membrane according to claim 1 wherein the polymeric ion-conducting membrane material has an equivalent weight in the range of and including 450 to 1000, such as 450 to 850.

21. A catalyst-coated membrane for a fuel cell or a water electrolyser comprising a reinforced ion-conducting membrane according to claim 1, with a cathode catalyst layer applied to a first face of the membrane and/or an anode catalyst layer applied to a second face of the membrane.

22. A membrane-electrode assembly for a fuel cell or a water electrolyser comprising (i) a reinforced ion-conducting membrane according to claim 1.

23. A water electrolyser or a fuel cell comprising a membrane-electrode assembly according to claim 22.
